(19) United States
(12) Patent Application Publication
(10) Pub. No.: US 2003/0039534 A1
(43) Pub. Date: Feb. 27, 2003

(54) Tailgate ramp with draw latch clamps

(76) Inventors: Vincent Radosevich, Seattle, WA (US); Joseph Gatchalian Consul, Everett, WA (US)

Correspondence Address: VINCENT RADOSEVICH, 4116 37TH AVE., SW, SEATTLE, WA, 98126, US

(21) Appl. No.: 09/938,990

(22) Filed: Aug. 24, 2001

(51) Int. Cl. E01D 1/00; B65G 67/02; B60P 1/00

(52) U.S. Cl. 414/537; 296/61

(57) ABSTRACT

A ramp device for loading wheeled vehicles, equipment, or articles onto a pickup truck or trailer. A ramp device, or set of ramp devices, which provides a roadway or skidway between ground level and a truck bed, and which additionally provides a solid path over the tailgate, and the gap between the tailgate and truck bed, thence into the bed. The ramp device folds to fit within a pickup truck bed for storage and transportation. The ramp device further comprises a clamping system which utilizes draw latches to clamp the ramp onto the tailgate. The clamping system is actuated by hand and is not coupled to the motion of the pivoting ramp member.

### BACKGROUND OF THE INVENTION

1. Field of Invention

This invention relates generally to loading ramps for loading wheeled vehicles into the bed of a truck or trailer. In particular, this invention pertains to locking devices on such ramp devices to prevent accidental release of the ramp from the vehicle.

2. Description of Prior Art

Some pickup tailgates lower all the way down, rotating 180 degrees from the closed position.

Others are designed to be removed quickly without tools. For such vehicles, ramps can be easily attached at, or near, the hinge line of the tailgate. Usually, however, tailgates only lower to a horizontal, or approximately horizontal position, and are not easily removable. This presents the following problems: 1) The lowered tailgate is an obstacle between the bed and the load. 2) The lowered tailgate is often an uneven surface for sliding and rolling things on. 3) There is usually, if not always, a gap between the tailgate and the bed which must somehow be crossed. 4) The tailgate is often considered a cosmetic surface which can be scratched or dented.

Because of the problems mentioned above, it is convenient to classify ramp devices according to the treatment of the original equipment tailgate. This classification strategy leads to the following broad groups: 1) The original equipment tailgate is bridged, or bypassed, by the ramp device without any cooperative interaction. 2) The original equipment tailgate is not modified, but is used to attach ramps. 3) The original equipment tailgate is modified to attach ramps. 4) The original equipment tailgate is replaced with a tailgate containing a ramp device.

Group 1 devices require no modification of and no interaction with the original equipment tailgate. Group 2 devices require no modification of the original equipment tailgate but do use the tailgate as a load carrying member. Group 3 devices require modification of the original equipment tailgate and use it to carry load. Group 4 devices completely replace the original equipment tailgate.

The present invention falls into group 2. Ramp devices that fall into a different group are considered to be so different, that they do not require close comparison to the present invention. Ramp devices that double as tailgate extensions are categorized by their use as a ramp. Ramp devices that fit into more than one category are placed in the group that has the lowest group number.

Their were two utility (US) one design (D) patent found in group 1. U.S. Pat. No. 5,553,762 and D 360,729 show devices that bridge the tailgate while it is in the closed position and provide an elevated roadway over the truck bed to stow wheeled machinery for transport. U.S. Pat. No. 5,810,546 shows a device that bridges the tailgate in the lowered position and stows water craft on a structure which rests on the bed of the pickup. These are different in form and way used from the present invention which attaches to the original equipment tailgate and provides a roadway directly to the bed of the truck.

Their are two US Patents in Group 2. U.S. Pat. No. 6,158,797 shows a device that is a truck bed extension which doubles as a ramp. In the ramp mode, it has a lip 19 which smooths the transition from the sloping ramp surface to the tailgate. Otherwise, it just rests on the tailgate and is held in position by gravity and friction. Furthermore, it teaches no special means for traversing the gap between the tailgate and the truck bed. The present invention is substantially different. Instead of being held in position just by gravity and friction, it also is held in position by draw latches, cables, and hooks. Furthermore, the present invention teaches a method for traversing the gap between the tailgate and the bed of the truck; namely, it utilizes a planar member to bridge the gap.

U.S. Pat. No. 6,059,344 shows a device that is similar to the present invention. Both utilize a mechanism to clamp onto the tailgate, and both utilize a traversing member to bridge the gap between the tailgate and the bed of the truck. The difference lies in the clamping mechanism. The mechanism shown in U.S. Pat. No. 6,059,344 couples the lowering action of the inclined portion of the ramp with the clamping action which holds the ramp to the tailgate. The present invention utilizes draw action clamps which are not coupled to the pivoting of the inclined portion of the ramp device. These two devices each have advantages and disadvantages. The clamping mechanism shown in U.S. Pat. No. 6,059,344 has the potential for fewer moving parts than the present invention because the inclined portion of the ramp device of U.S. Pat. No. 6,059,344 doubles as a clamp lever. The ramp device shown in U.S. Pat. No. 6,059,344 also has the potential for quicker installation than the present invention since the clamping action of the ramp device of U.S. Pat. No. 6,059,344 takes place as the ramp device is put into position. The present invention has to be put into position; then the draw latches have to be worked separately to clamp the device to the tailgate.

Compared to the present invention, the device shown in U.S. Pat. No. 6,059,344 has two disadvantages: 1) U.S. Pat. No. 6,059,344 has to be readjusted depending on the load on the pickup, because as the load increases the tailgate gets lower to the ground which decreases the ramp angle with respect to the plane of the tailgate, and therefore, decreases the clamping pressure. The present invention has no such problem because the clamping action is not coupled with the ramp hinge action. 2) The ramp device shown in U.S. Pat. No. 6,059,344 can not be used at low angles with respect to the plane of the tailgate, because the ramp has to move through some angular rotation to make the clamping mechanism work. The present invention has no such problem because the draw latches clamp equally as hard when the ramp is at low or high angles with respect to the plane of the tailgate.

There were four utility patents and one design patent in group 3. The devices shown in U.S. Pat. Nos. 3,976,209, 4,098,414, and 5,816,638 attach to the original equipment tailgate with mechanical fasteners which involves drilling into the original equipment tailgate. This constitutes a modification to the tailgate which differs from the present invention which requires no such modification. Design Pat. No. 316,771 shows a ramp that attaches to the free edge of the original equipment tailgate after it has been lowered to a horizontal position. Attachment is by means of pins which fit into holes drilled into the edge of the tailgate. Again, this is different from the present invention which requires no drilling of holes in the tailgate. U.S. Pat. No. 4,795,304 shows a device that is attached to the outer tailgate surface with brackets which must be screwed or welded in place. This is different from the present invention which requires no modification of the tailgate.

None of the patents in group 3 teach any means of traversing the gap between the tailgate and the bed of the truck. The present invention has a horizontal traversing member which bridges the gap. This makes all the patents in group 3 different from the present invention.

There were two utility patents and one design patent found in group 4. Both utility patents, U.S. Pat. Nos. 5,273,335 and 5,907,276, show tailgate replacement devices that double as ramps. They both show or mention sliding and folding members to convert the device between a tailgate function and a ramp function. Both are different from the present invention because they require complete replacement of the original equipment tailgate while the present invention does not. U.S. Pat. No. 5,273,335 shows a device that mounts just inside the rear opening of the bed with the upper most hinges mounted on the bed of the truck; thus, there is no gap between the tailgate and the bed. However, there is an objectionable drop from the ramp structure to the bed of the pickup, due to the ramp structure thickness and the location of the hinges. This is smoothed out somewhat by a plate 44. U.S. Pat. No. 5,907,276 shows a hinging member 26 which will create a gap or drop between the end of the ramp and the bed of the truck. We could find no drawing or text which teaches a method for dealing with such a gap or drop. The present invention bridges the gap between the tailgate and the truck bed with a thin tapered member creating a minimal drop from the ramp structure to the bed of the truck, making it different from the devices shown in U.S. Pat. Nos. 5,273,335 and 5,907,276.

Design Pat. 354,603 shows the tailgate removed and replaced with a bar which supports the ramps. Again, this is different from the present invention which does not require the tailgate to be removed from the truck. Also, D 354,603 shows an objectionable drop that exists between the ramp ends and the truck bed which does not exist in the present invention.

### OBJECTS OF THE INVENTION

It is an object of the invention to provide a ramp or set of ramps to load vehicles, equipment, or objects onto a truck or trailer which is equipped with a tailgate that drops into a position which is coplanar or very nearly coplanar with the bed.

It is a further object of the invention to provide secure, but removable attachment of a ramp to a vehicle to prevent accidental dropping of the item being loaded.

It is a further object of the invention that the ramps be easily installed and removed without the use of tools.

It is a further object of the invention that the clamping mechanism be adjustable with simple hand tools to fit many different tailgate and bed dimensions.

It is a further object of the invention that the ramps span the gap between the tailgate and the bed, and that the ramps protect the inner surface of the tailgate from damage incidental to loading.

It is a further object of the invention that curbs be provided to prevent a vehicle being loaded from running off the ramps.

It is a further object of the invention that the ramps be foldable for stowage and transport.

### SUMMARY OF THE INVENTION

A ramp device for loading wheeled vehicles, equipment, or articles onto a pickup truck or trailer. A ramp device, or set of ramp devices, is placed on the horizontally extend tailgate of a pickup truck. One portion of the ramp device traverses the tailgate, and the gap between the tailgate and the truck bed, and the other portion slopes downward from the end of the tailgate to the ground.

This invention is particularly suited to load small wheeled equipment such as lawn mowers, small tractors, cultivators, wheelbarrows, light motorcycles, and the like into a pickup truck. Nothing in the design precludes it from being designed for heavier equipment, ATVs, barrels, farm tractors, small bulldozers, and the like. It should be noted, however, that the tailgate and its supports must have a load carrying capability greater than, or equal to, the load carrying capability of the ramp or ramps.

The ramp assembly is hinged at a location close to the outer edge of the tailgate forming two portions: 1) a sloping ramp, and 2) a roadway over the tailgate, and the gap between the tailgate and the truck cargo bed. The roadway bridges the gap and provides a solid track over the tailgate panels thus avoiding both structural and paint damage to the tailgate inner surface. Also, the roadway avoids having to lift the article being loaded over the gap. The ramp device further comprises a clamping system that grips the tailgate firmly. The clamps utilize draw latches, cables, and hooks to grip the tailgate. This prevents the ramps from shifting which could cause the vehicle or article being loaded to be dropped off the ramp, or ramps. The ramp system further comprises a set of curbs to guide wheeled vehicles over the ramp. Also, the ramp device folds to fit within a standard size pickup truck bed.

One other design for ramps has been found that clamps onto a tailgate and provides a firm surface over the gap between the tailgate and bed.

### BRIEF DESCRIPTION OF THE DRAWINGS

FIG. 1 shows the invention in place on the back of a pickup truck. FIG. 2 is a plan view of the invention showing the clamping mechanism in the open position. Note that only one side of the ramp device is shown. The other side is identical except for curb 10 which is present only on the side shown. FIG. 3 is an elevation view of the invention showing the clamping mechanism in the open position. FIG. 4 is an elevation view of the invention showing the clamping mechanism in the closed position. FIG. 5 is an elevation view showing the ramp device in the folded position for stowage and transport.

### DETAILED DESCRIPTION OF THE PREFERRED EMBODIMENT

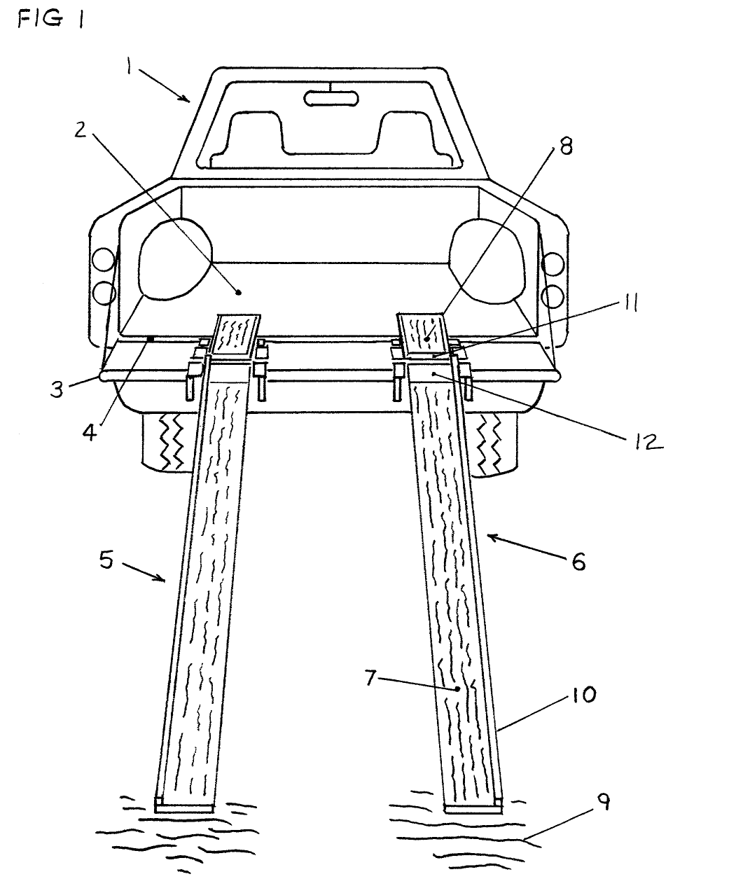

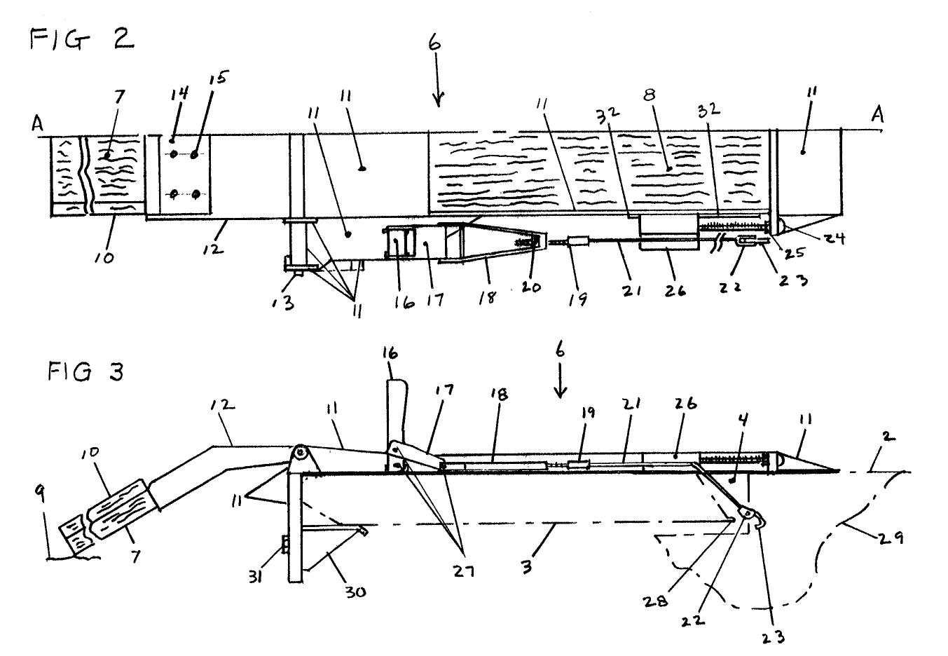

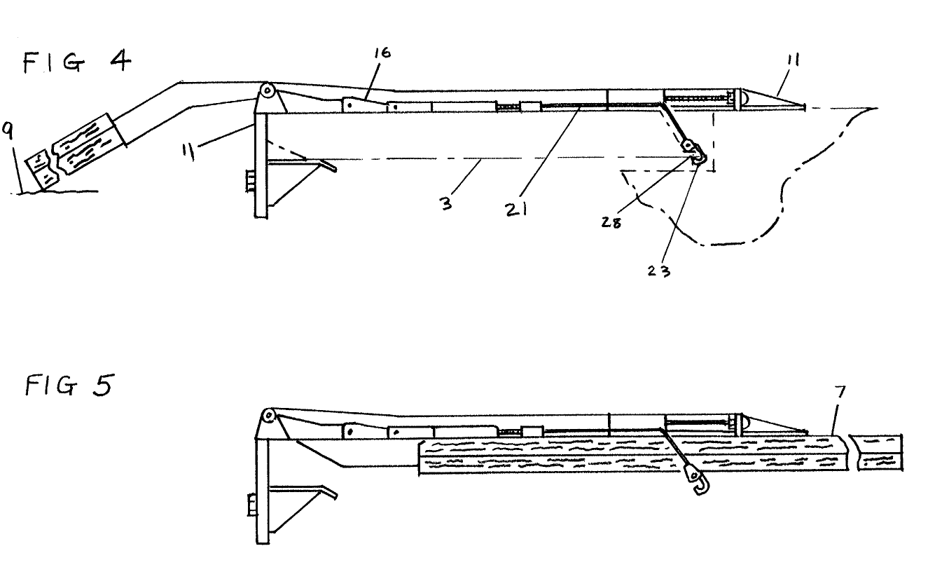

Referring to FIG. 1, truck 1, is readied for loading by lowering tailgate 3. Ramps 5 and 6 are attached to the tailgate. Ramps 5 and 6 are mirror images of each other so describing 6 also describes 5. The front portion 8 of the ramp overlays the tailgate and the gap 4 between tailgate 3 and bed 2 of the truck. Front portion 8 extends into cargo bed 2 sufficiently far to provide load bearing support for one of its ends. The tailgate provides support for the other end of front portion 8. Rear portion 7 is hinged to front portion 8 at one end with the other end resting on ground 9.

Referring to FIG. 2, ramp 6 includes a rear portion 7, a curb 10, hinge piece 12, and cover plate 14. Rear portion 7 is rigidly attached to hinge piece 12 by way of screws 15 which also hold cover plate 14 in place. Hinge piece 12 is connected to frame 11 by way of hinge pin 13. Front portion 8 is connected to frame 11 by screws not shown. Together, referring to FIG. 1, these parts form a roadway from ground 9 up to tailgate 3, across tailgate 3 and gap 4, and into bed 2 of the truck.

Referring to FIGS. 2 and 3, the clamping mechanism, shown in the open position, is comprised of handle 16, connector 17, yoke 18, threaded cable termination 19, nut 20, cable 21, cable strap termination 22, and hook 23. The adjusting mechanism is comprised of guide block 26, adjusting screw 24, lock nut 25. Guide block 26 slides on rail 32 which is welded to frame 11. The front of the ramp device is held to the tailgate 3 in the vertical direction by bracket 30 which is adjustable for a range of tailgate thicknesses using bolt 31.

FIG. 4 shows the present invention with the clamping mechanism in the closed position. The mechanism when closed traps tailgate 3 between hook 23 and the front of traversing frame 11. Note handle 16 has been rotated 90 degrees which puts cable 21 in tension. Handle 16 is held in the closed position by an over centering action typical of draw latch mechanisms.

FIG. 5 shows the front portion 7 rotated 180 degrees into the folded position for stowage and transport.

The ramps can be fabricated from a combination of welded sheet metal and wood as shown, or other materials that could include fiberglass, aluminum extrusions, etc.

### Alternative Embodiments and Accouterments

For some applications, two curbs on each ramp may be found desirable.

For some applications removable curbs may be found desirable.

For some applications strengthening ribs may be required on the underside of the forward or rear portions of the ramp device.

An additional hinge, not shown, may be included on the ramp rear portion 7 to permit further folding and shortening for storage. This would of course increase the weight and complexity of the invention.

The clamping mechanism could take many forms; some examples are as follows: 1) The draw latch (see FIG. 2, parts 16, 17, and 18) could be replaced by a screw mechanism, a cam mechanism, a ratcheting mechanism, or a friction mechanism. 2) The flexible cable (see FIG. 2, part 21) could be replaced by a chain, a system of hinged links supported by brackets, or a nonmetallic fiber cable. 3) The adjusting screw mechanism (see FIG. 2, parts 24, 25, and 26) could be replaced by a ratchet mechanism, a sliding shaft with holes through which a lock pin could be inserted, etc. 4) The adjusting mechanism could be combined with the cable and hook and the draw latch eliminated. The clamping action could then be provided by a cam, screw, or the like mounted some where on frame 11.

Springs could be provided to prevent excessive or uneven clamping pressures.

Rubber, foam pads, or plastic pads could be added to prevent damage to cosmetic surfaces of the truck or trailer.

### How to use the Invention

Referring to FIG. 1, truck 1 is readied for loading by lowering tailgate 3, and ramps 5 and 6 are deployed where front portions 8 of the ramps overlay tailgate 3. The extending portion of ramp 7 is lowered to ground 9. Referring to FIG. 3, the ramp device is slid forward such that bracket 30 goes under tailgate 3. At this point gap 4 between tailgate 3, and bed 2 should be bridged by the horizontal portion of the ramp and the inclined portion should form a roadway from ground 9 to the outer edge of tailgate 3.

The ramp device can now be adjusted to fit the particular vehicle if necessary. Adjustment would proceed as follows: First, referring to FIG. 3, loosen bolts 31 with a wrench then slide brackets 30 upward until contact with tailgate 3 is achieved. Then tighten bolts 31 with a wrench. Second, loosen lock nuts 25 as necessary, and turn adjusting screws 24 as necessary, and slide adjusting block 26 as necessary until the right most edge of the adjusting block is over the edge of tailgate 3. Tighten screws 24 and nuts 25 until adjusting block 26 is locked in position. Third, open the latch handles 16, see FIGS. 3 and 4, and place hooks 23 on lip 28 of tailgate 3. Loosen nuts 20 and screw threaded terminations 19 into yokes 18 until the cables have a small amount of slack in them. Now close handles 16. If the cable is tight, the mechanism is adjusted correctly. If not, open handles 16 and screw in the threaded terminations some more. Close handles 16. If the cables are tight, the mechanisms are adjusted correctly. If not, repeat the above procedure until tight cables are achieved. Then tighten lock nuts 20. The ramp is now clamped on the tailgate and can be taken on and off this tailgate without further adjustment.

The ramps can now be used for loading cargo. They can be positioned to accommodate a variety of small wheeled equipment by varying the distance between the ramps.

After use, referring to FIG. 3, the ramps are removed by opening handles 16 and pulling hooks 23 free from lip 28. The ramps can now be removed from the tailgate, and folded for storage as shown in FIG. 5.

Thus, it is apparent that there has been provided in accordance with the invention, a truck

### ELEMENT INDEX

1. Pickup truck—generally

2. Pickup truck bed—generally

3. Pickup truck—tailgate

4. Gap between tailgate and bed

5. Ramp, LH side—generally

6. Ramp, RH side—generally

7. Inclined (rear) portion of ramp, RH side

8. Horizontal (front) portion of ramp, RH side

9. Ground, earth, or roadway

10. Curb RH side

11. Frame

12. Hinge piece

13. Hinge pin

14. Cover plate

15. Fasteners, flat head screws

16. Handle

17. Connector

18. Yoke

19. Threaded cable termination

20. Lock nut

21. Cable, steel

22. Cable termination, strap type

23. Hook

24. Adjustment screw

25. Nut

26. Adjustment block

27. Draw latch pins

28. Lower, inner lip, tailgate inner edge

29. Truck adjacent to tailgate inner edge

30. Bracket

31. Bolt loading ramp that fully satisfies the objects, aims, and advantages set forth above.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be considered to fall within the scope of the invention as defined by the claims which follow.

The embodiments of the invention in which an exclusive property right or privilege is claimed are defined as follows:

I claim:

1. A loading ramp for a vehicle having a horizontally hinged tailgate mounted to the rear edge of a cargo bed comprising:
a. A generally planar elongated rectangular ramp member extending generally between the tailgate and a ramp receiving surface (usually the ground), and a generally planar elongated rectangular traversing member for traversing the tailgate and extending into the rear portion of said cargo bed, and each member having a long axis and a short axis, and each member having an upper and a lower surface, and each member having long edges on opposite ends of said short axis, and each member having an inner end edge and an outer end edge on opposite ends of said long axis.
b. A hinge connecting said ramp member and said traversing member, and said hinge being attached to said inner end edges parallel to each members's short axis, and
c. Two clamping mechanisms mounted on said traversing member, and which, through manual application of force without the aid of hand tools, clamp the traversing member to the pickup tailgate, and
d. An adjusting mechanism which, with the use of simple hand tools, will adjust to fit many tailgates of varying dimensions.

2. The inclined portion of the ramp device can pivot from a nearly parallel relationship to the plane of the cargo bed to an angle in excess of 45 degrees with the plane of the cargo bed without significantly changing the clamping forces that hold the ramp device to the pickup.

3. The elongated member, of claim 1.a., extends generally between the ramp surface and the tailgate. Further, it comprises no curb, 1 curb, or 2 curbs attached to a long edge or edges of the member. Similarly, the elongated traversing member of claim 1.a., generally traversing the tailgate and extending a short distance into the bed, further comprising no curb, 1 curb, or 2 curbs attached to a long edge or edges of the member.
